(19) United States
(12) Patent Application Publication
(10) Pub. No.: US 2006/0226791 A1
(43) Pub. Date: Oct. 12, 2006

(54) Method of adopting square voltage waveform for driving flat lamps

(75) Inventors: Jin-Chyuan Hung, Hsinchu City (TW); Qiuka Huang, Cao-Lu Town (CN); Jianping Ying, Qiu-shi Village (CN); Ching-Ho Chou, Taipei City (TW); Kung-Tung Pan, Taichung City (TW); Yui-Shin Fran, Hsinchu City (TW)

Correspondence Address: BRUCE H. TROXELL, SUITE 1404, 5205 LEESBURG PIKE, FALLS CHURCH, VA, 22041, US

(73) Assignee: Delta Optoelectronics, Inc.

(21) Appl. No.: 11/414,330

(22) Filed: May 1, 2006

(30) Foreign Application Priority Data
Apr. 11, 2005 (TW) 094138736

(51) Int. Cl. H05B 37/02

(52) U.S. Cl. 315/291

(57) ABSTRACT

The present invention relates to a method adopting square voltage waveform for driving a flat lamp used as the light source of a flat panel display or a common light fixture, the method comprising steps of: using a power unit to convert direct current into voltage of square waveform; using a voltage booster to raise the crest of the square voltage waveform to a specific trigger voltage capable of turning on the flat lamp; and providing a pulse-type current while enabling the pulse-type current to be just larger enough to break the dielectric barrier of the flat lamp.

### FIELD OF THE INVENTION

The present invention relates to a method of adopting square voltage waveform for driving a lamp, and more particularly, to a method of driving a flat lamp by a voltage of square waveform or a voltage of multi-step square waveform instead of conventional sinusoidal voltage, by which the over-pulse peak of the square waveform or multi-step square waveform is raised to a specific trigger voltage of the flat lamp for enabling the driving current of the flat lamp to be a pulse-type current capable of effectively overcoming the dielectric barrier thereof, whereas the pulse-type current is generated starting at the steep fronts of the square voltage, i.e. at the ascending/descending point of each over-pulse peak of the square wave, so that the luminous efficiency of the flat lamp can be enhanced while reducing the operating temperature of the same.

### BACKGROUND OF THE INVENTION

LCDs are nonemissive light devices, which means they do not produce any form of light. Instead they block/pass light reflected from an external light source provided by a back light module. Currently, it is common to use a back light module with multiple thin cold cathode fluorescent lamps as the light source of illumination to give the display sufficient contrast and brightness and thus satisfy the demands of high brightness LCDs. However, in order to providing uniform illumination across the LCD surface and luminance that is high enough to produce good contrast in a day environment, the back light module with multiple thin cold cathode lamps must have a diffuser that is thick enough to takes the numerous points of light and uniformly spreads it out over the entire area of the display. It is inevitable that a backlight module with diffuser will have to face the problems of increasing overall thickness and operating temperature. Moreover, the brightness decay of each cold cathode lamp is speeding up after long-hour high-temperature operation while the speed of the decaying can be varied from one cold cathode lamp to another that is going to cause a high brightness LCD to suffer the phenomenon of uneven illumination. Therefore, flat fluorescent lamps become a preferred option to be used as the backlight of liquid crystal display.

Please refer to FIG. 1, which shows waveforms of driving voltage and current used for driving a cold cathode flat lamp according to prior arts. As a conventional flat lamp is driven by voltage of sinusoidal waveform 11 and corresponding sinusoidal current 12, a notable amount of power is lost since there is a very large circulating current flowing through the driving circuit of the flat lamp, and consequently, not only the luminous efficiency of the flat lamp is reduced accordingly, but also the temperature of a backlight module using the flat lamp is increased.

Please refer to FIG. 2, which shows another waveforms of driving voltage and current used for driving a cold cathode flat lamp according to prior arts. In FIG. 2, a single unipolar voltage pulse has been used to stress a flat lamp, however, this technique is not very efficient, as it does not result in large current transients through the device. That is, the flat lamp is driven by a smaller driving current 22 of the driving voltage 21 of unipolarity. Since the flat lamp is driven by unipolar voltage pulse, only a single monochrome light is discharged from the flat lamp. Therefore, the flat lamp driven by unipolar voltage pulse has shortcomings listed as following:
(1) As a flat lamp is driven to emit light by unipolar voltage pulse and as the increasing of the operating time of the flat lamp, the positive/negative ions generated from the ionization of molecules of inert gas filled in the flat lamp will accumulate and adhere in the vicinity of the electrodes of the flat lamp, that consequently will cause the electrolytic effect and wall charge effect to occur. When the electrolytic effect and wall charge effect are formed in the flat lamp, the driving voltage used to drive the flat lamp must be raised so as to overcome the dielectric barrier caused thereby. Because of that, not only the luminous efficiency of the flat lamp is reduced and the temperature of the flat lamp is increased, but also it will cause the electric arc generated in the flat lamp to be unstable.
(2) In order to overcome the aforesaid dielectric barrier, the driving voltage usually will be boosted to over 2 kV. However, as the driving voltage is boosted, the corresponding electromagnetic interface (EMI) is also enhanced, such that as the backlight module using the foregoing flat lamp is operating, it is going to fail the relating official test of EMI/EMC, such as CE. FCC, etc.

Please refer to FIG. 3, which shows yet another waveforms of driving voltage and current used for driving a cold cathode flat lamp according to prior arts. The driving voltage is a synthesized wave 33 of trapezoid waveform which is formed by combining a first sinusoidal wave 31 with a third harmonic wave 32 by a 3^{rd} harmonic injection method. Although the aforementioned problem of large circulating current can be improved by the use of the synthesized wave 32 as the driving voltage of a flat lamp so that the luminous efficiency of the flat lamp is improved and also the temperature of a backlight module using the flat lamp is reduced. However, the synthesized voltage 32 is still troubled by the shortcomings listed as following:
(1) The transformer used in the driving circuit of the flat lamp must be controlled precisely so as to enable the resonance frequency formed by the cooperation of the leakage inductance of the transformer and an external harmonic capacitor to be exactly three times of the fundamental frequency of switching frequency. Fail to do so will fail to form the desired synthesized wave 33 of trapezoid waveform.
(2) The synthesized wave of trapezoid waveform formed at the high-voltage side of the transformer is going to cause the transformer to have addition circulating current, and thus there is also a power loss problem that must be overcome similarly by raising driving voltage. However, the raised driving voltage will cause EMI problem.

Therefore, it is required to have a driving method capable of improving the luminous efficiency of an external electrode flat lamp, which can replace the conventional method of driving a cold cathode fluorescent lamp or external electrode cold cathode fluorescent lamp by a driving voltage of sinusoidal waveform.

### SUMMARY OF THE INVENTION

In view of the disadvantages of prior art, the primary object of the present invention is to provide a method of adopting square voltage waveform for driving a lamp, that is, a method of driving a flat lamp by a voltage of square waveform or a voltage of multi-step square waveform instead of conventional sinusoidal voltage, by which the over-pulse peak of the square waveform or multi-step square waveform is raised to a specific trigger voltage of the flat lamp for enabling the driving current of the flat lamp to be a pulse-type current capable of effectively overcoming the dielectric barrier thereof, whereas the pulse-type current is generated starting at the steep fronts of the square voltage, i.e. at the ascending/descending point of each over-pulse peak of the square wave, so that the luminous efficiency of the flat lamp can be enhanced while reducing the operating temperature of the same.

To achieve the above objective, the present invention provides a method of adopting square voltage waveform for driving a flat lamp, the flat lamp being the light source of any illumination device/flat panel display adopting a means of dielectric barrier discharging, such as external electrode cold cathode fluorescent lamps and plasma displays, the method comprising steps of:
using a power unit to convert direct current into a voltage of square waveform;
using a voltage booster to raise an over-pulse peak of the square voltage waveform to a specific trigger voltage capable of turning on the flat lamp; and
providing a pulse-type current while enabling the pulse-type current to be just larger enough to break the dielectric barrier of the flat lamp.

Preferably, the over-pulse peak of the trigger voltage raised by the voltage booster enables the driving current of the flat lamp to be a pulse-type current.

Preferably, the square waveform can be a multi-step square waveform.

Preferably, the pulse-type current is generated starting at the steep fronts of the square voltage, i.e. at the ascending/descending point of each over-pulse peak of the square waveform.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows waveform of a driving voltage and current used for driving a cold cathode flat lamp according to prior arts

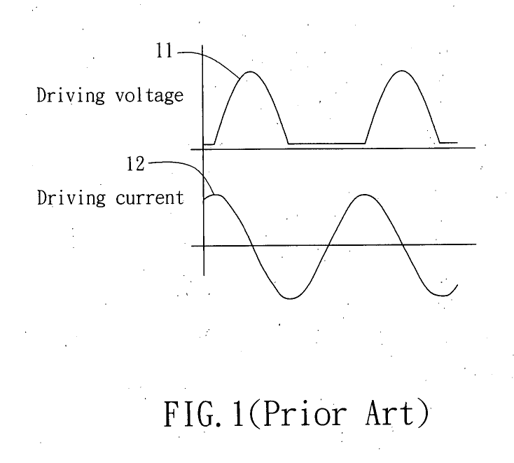

FIG. 2 shows another waveforms of driving voltage and current used for driving a cold cathode flat lamp according to prior arts.

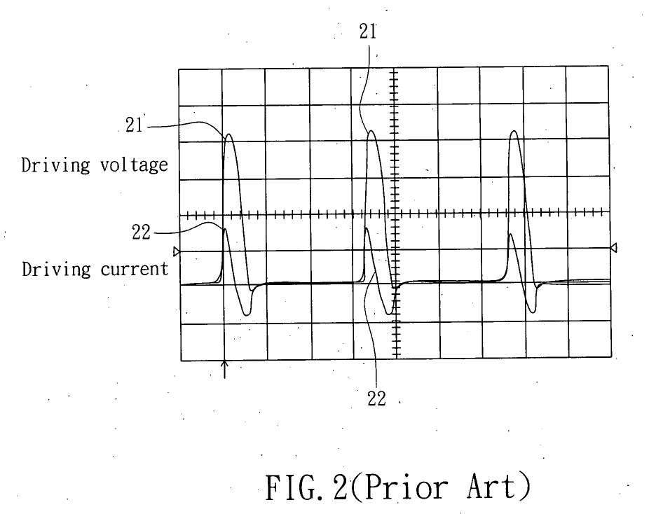

FIG. 3 shows yet another waveforms of driving voltage and current used for driving a cold cathode flat lamp according to prior arts.

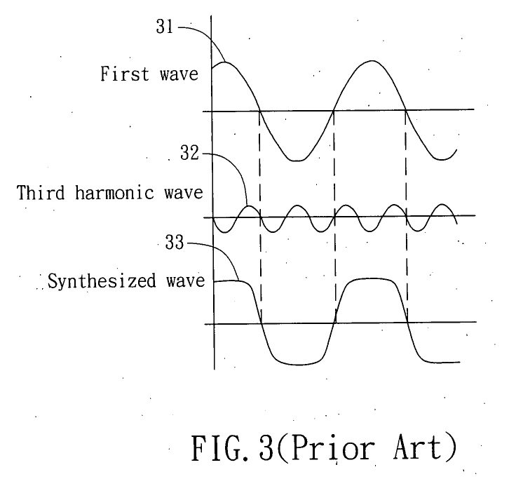

FIG. 4 shows the relation between light being emitted by a cold cathode flat lamp and its driving voltage/driving current according to the present invention.

FIG. 5 shows actual waveforms of a driving voltage and current used for driving a cold cathode flat lamp according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

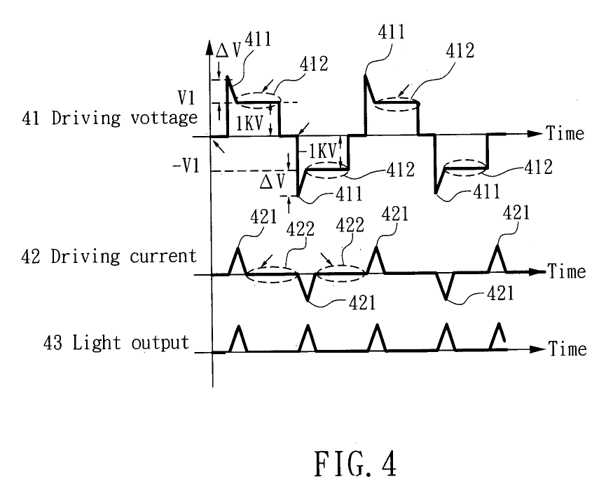

Please refer to FIG. 4, which shows the relation between light being emitted by a cold cathode flat lamp and its driving voltage/driving current according to the present invention. As seen in FIG. 4, each period of the driving voltage 41 is composed of a sub-period of trigger voltage 411 and a sub-period of maintain voltage 412, which correspond to a sub-period of discharging current 421 and a sub-period of no current 422 of a period of driving current 42 corresponding thereto. It is noted that each sub-period of discharging current 421 is related to a corresponding light-emitting period of the flat lamp 43. The present invention provides a method for driving a flat lamp, the flat lamp being the light source of any common illumination device or flat panel display, such as external electrode cold cathode fluorescent lamps, flat lamps of no mercury and liquid crystal displays, the method comprising steps of:
using a power unit to convert direct current into a voltage of square waveform; whereas the power unit is an electronic device capable of amplifying micro signals, such as metal oxide semiconductor field effect transistor (MOSFET), insulated gate bipolar transistor (IGBT), and bipolar junction transistor (BJT);
using a voltage booster to raise an over-pulse peak of the square voltage waveform to a specific trigger voltage capable of turning on the lamp; whereas the over-pulse peak of the trigger voltage raised by the voltage booster enables the driving current of the flat lamp to be a pulse-type current, and the voltage booster is a device selected from the group consisting of a high frequency transformer, an autotransformer, and a coupled inductor; and
providing a pulse-type current while enabling the pulse-type current to be just larger enough to break the dielectric barrier of the lamp; whereas the pulse-type current is generated starting at the steep fronts of the square voltage, i.e. at the ascending/descending point of each over-pulse peak of the square waveform.

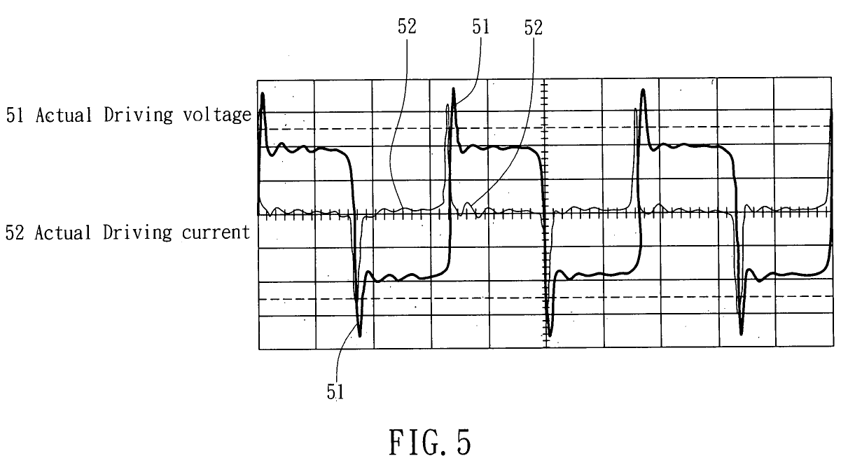

Please refer to FIG. 5, which shows actual waveforms of a driving voltage and current used for driving a cold cathode flat lamp according to the present invention. The actual waveforms shown in FIG. 5 reflect the adaptation of the present invention to the driving circuit of a flat lamp of no mercury. As seen in FIG. 5, an over-pulse peak of the trigger voltage raised by the voltage booster enables the driving current of the flat lamp to be a pulse-type current while the square voltage waveform is affected by harmonic waves and is a multi-step square waveform. It is noted that the voltage within the period of no current is oscillating, and the pulse-type current is generated starting at the steep fronts of the square voltage, i.e. at the ascending/descending point of each over-pulse peak of the square waveform while enabling the pulse-type current to be just larger enough to overcome the dielectric barrier of the lamp's glass.

The features and advantages of the present invention as it is being applied to a flat lamp of no mercury are as following:
(a) Directly current voltage is converted into a relating voltage of square waveform by a power unit;
(b) The voltage of square waveform is raised to a trigger voltage capable of turning on a flat lamp by using a device such as a conventional transformer, an autotransformer, and a coupled inductor, etc.;
(c) After the lamp is on, the diving voltage can be maintained to a constant or just decreased slightly, however, the waveform of the driving voltage is maintained to be a square wave in general;
(d) The driving current is a pulse-type current, which is generated starting at the steep fronts of the square voltage, i.e. at the ascending/descending point of each over-pulse peak of the square waveform;
(e) The pulse-type current of the present invention is suitable to be applied to external electrode flat lamps, since the use of pulse-type current in the present invention is capable of enhancing the luminous efficiency of the flat lamp by solving the problem caused by dielectric barrier, that is, the pulse-type current generated by a driving voltage of square waveform is especially suitable to be applied to any lamps adopting a means of dielectric barrier discharging for emitting light, such as external electrode cold cathode lamps, plasma displays, and external electrode flat lamps;
(f) Maintaining the square waveform of the driving voltage after a flat lamp is turned on thereby is helpful to turn on the flat lamp the next time, since the residual charge stored in the dielectric layer can help to reduce the driving voltage of the flat lamp for preparing the same for the next turn-on;
(g) The measure of the driving voltage of square waveform and its trigger voltage adopted in the present invention is not related to the size of the flat lamp that can be driven thereby, and thus the method of the present invention is especially suitable to be applied in large-size flat lamps/displays.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of adopting square voltage waveform for driving a lamp, the lamp being the light source of any illumination device/flat panel display adopting a means of dielectric barrier discharging, the method comprising steps of:
using a power unit to convert direct current into a voltage of square waveform;
using a voltage booster to raise an over-pulse peak of the square voltage waveform to a specific trigger voltage capable of turning on the lamp; and
providing a pulse-type current while enabling the pulse-type current to be just larger enough to overcome the dielectric barrier of the lamp's glass.

2. The method of claim 1, wherein the lamp is a cold cathode fluorescent lamp.

3. The method of claim 1, wherein the lamp is a flat lamp.

4. The method of claim 3, wherein the flat lamp is a flat lamp of no mercury.

5. The method of claim 1, wherein the voltage booster is a high frequency transformer.

6. The method of claim 1, wherein the voltage booster is an autotransformer.

7. The method of claim 1, wherein the voltage booster is a coupled inductor.

8. The method of claim 1, wherein the power unit is an electronic device capable of amplifying micro signals.

9. The method of claim 1, wherein the power unit is a device selected from the group consisting of a metal oxide semiconductor field effect transistor, an insulated gate bipolar transistor, and a bipolar junction transistor.

10. The method of claim 1, wherein the flat panel display is a device selected from the group consisting of liquid crystal displays and plasma displays.

11. The method of claim 1, wherein the over-pulse peak of the trigger voltage raised by the voltage booster enables the driving current of the flat lamp to be a pulse-type current.

12. The method of claim 1, wherein the square waveform can be a multi-step square waveform.

13. The method of claim 1, wherein the pulse-type current is generated starting at the ascending/descending point of each over-pulse peak of the square waveform.
